(19) United States
(12) Patent Application Publication
(10) Pub. No.: US 2006/0139164 A1
(43) Pub. Date: Jun. 29, 2006

(54) Composite intrusion detection sensor

(76) Inventor: Masatoshi Tsuji, Otsu (JP)

Correspondence Address: WENDEROTH, LIND & PONACK, L.L.P., 2033 K STREET N. W., SUITE 800, WASHINGTON, DC, 20006-1021, US

(21) Appl. No.: 11/297,359

(22) Filed: Dec. 9, 2005

(30) Foreign Application Priority Data
Dec. 14, 2004 (JP) 2004-360890

(51) Int. Cl. G08B 19/00; G08B 13/00

(52) U.S. Cl. 340/522; 340/541

(57) ABSTRACT

According to an embodiment, a composite intrusion detection sensor includes a microwave sensor that transmits microwaves toward a detection area and based on reflected waves of the microwaves from an object present in the detection area detects and outputs distance information about a distance to the object and first distance change information about a distance change within a predetermined time interval; an image sensor that captures images within the detection area, and based on changes between images captured in a time series, detects and outputs on-image movement amount information, which represents the amount of movement of the detected object in the images within the predetermined time interval; and a computation means for judging, based on the distance information, the first distance change information, and the on-image movement amount information whether or not the object is an intruder.

### CROSS-REFERENCE TO RELATED APPLICATION

This application claims priority under 35 U.S.C. §119(a) on Patent Application Number 2004-360890, filed in Japan on Dec. 14, 2004, the entire contents of which are hereby incorporated by reference.

### BACKGROUND OF THE INVENTION

1. Field of Invention

The present invention relates to composite intrusion detection sensors that combine a plurality of methods for detecting intruders and the like into a detection area established within an alert territory, and in particular to composite intrusion detection sensors that jointly employ a microwave sensor and an image sensor.

2. Related Art

Conventionally, as one form of a intrusion detection sensor, microwave sensors are known (see JP H7-37176A (hereinafter referred to as “Patent Document 1”) for example) that emit microwaves toward a detection area, and when a human figure (an intruder) is present in the detection area, the human figure is detected by receiving the reflected waves (microwaves modulated due to the Doppler effect) from the human figure.

Moreover, one type of microwave sensor is known that uses a plurality of microwaves of different frequencies to measure the distance to an object (hereinafter referred to as “target”) such as a human figure that is present in the detection area. This type of sensor emits, for example, two microwaves of different frequencies toward the detection area and detects the phase difference between two IF signals based on the respective reflected waves. The phase difference is correlated with the distance to the target in that there is a tendency for the phase difference to also increase for larger distances to the target. In other words, it is possible to measure the distance to the target by determining the phase difference. Furthermore, by identifying temporal changes in the phase difference, it is also possible to determine whether or not the target in the detection area is moving. This makes it possible, for example, to determine only a target that is moving in the detection area as a target to be detected (an intruder).

However, there is a possibility that a phase difference will be created by the shaking of trees and plants or the like due to wind when this type of sensor is installed outdoors, which may lead to the trees and plants or the like to be erroneously detected as a target to be detected, thus resulting in a false alarm being issued. Similarly, there also is a possibility that a phase difference will be created by the rotational movement of a ventilation fan or the shaking of such items as blinds or curtains due to wind when this type of sensor is installed indoors, and in this case, too, objects other than human figures may be erroneously detected as targets to be detected, thus resulting in a false alarm being issued.

Accordingly, the inventors of the present invention have already proposed technology (see JP 2003-207462A; hereinafter referred to as “Patent Document 2”) for avoiding false alarms by accurately carrying out discrimination between targets to be detected, such as human figures, and objects that are not to be detected (such as plants and fans for example). In the proposed technology, the amount of change per unit of time in the relative distance to a target present in the detection area is measured based on the reflected waves, and the target is determined to be a target to be detected only when the amount of change has at least a predetermined threshold value. That is, the movement distances of plants shaking due to the wind or of rotating fans are minor in comparison to that of a human figure or the like to be detected, which involve large movement distances. By identifying this difference, a determination is made as to whether or not an item is a target to be detected.

On the other hand, with surveillance equipment utilizing image sensors, an image sensor is installed at the ceiling or the like of a room, and the appearance of the room is observed diagonally from above. For example, by computing image differences between frames, it is possible to extract the motion component and to detect from such difference images a person having intruded into the room.

However, when an image sensor is used and subjected to light from car headlights and the like, it exhibits halation, and under such conditions the detection of human figures becomes difficult. Furthermore, a problem has been encountered of erroneously detecting changes of shadow and sunlight in the surveillance area as human figures.

Accordingly, composite surveillance equipment has been proposed as well (see JP 2000-348265A (hereinafter referred to as “Patent Document 3”) for example), which through using microwave sensors and image sensors together accomplishes target object detection with high reliability, such that missed alarms in the case of halation can be prevented, while it is possible to also deal with the problem of false alarms due to small objects such as insects. This composite surveillance equipment is characterized by comprising a microwave sensor for transmitting and receiving microwaves with respect to a surveillance area and outputting a reception signal, an image sensor for picking up an image of the surveillance area and outputting image information, and a surveillance unit for performing surveillance of the surveillance area based on the reception signal and the image information.

Nevertheless, in the conventional art disclosed in above-mentioned Patent Document 2, when the above-mentioned threshold is set large so as to avoid as much as possible any false alarm due to close range plants and trees or the like when installed outdoors, there was the possibility of not being able to precisely detect an intruder in cases such as when the intruder traverses the surveillance target area at a location comparatively distant from the microwave sensor.

Also, in the conventional art disclosed in above-mentioned Patent Document 3, there are cases in which adequate judgment is impossible because movement distance, movement speed, and the like of the object suspected to be an intruder are not considered.

### SUMMARY OF THE INVENTION

An object of the present invention is to provide a composite intrusion detection sensor that, based on joint use of a microwave sensor and an image sensor, always accurately calculates the movement distance, movement speed and the like of an object suspected to be an intruder, that can accurately detect an intruder from an overall judgment that also includes continuity of movement and the like, that has few false alarms and missed alarms, and has high reliability;

A composite intrusion detection sensor in accordance with the present invention comprises a microwave sensor that transmits microwaves toward a detection area and based on reflected waves of the microwaves from an object present in the detection area detects and outputs distance information about a distance to the object and first distance change information about a distance change within a predetermined time interval; an image sensor that captures images within the detection area, and based on changes between images captured in a time series, detects and outputs on-image movement amount information, which represents the amount of movement of the detected object in the images within the predetermined time interval; and a computation means for judging, based on the distance information, the first distance change information, and the on-image movement amount information whether or not the object is an intruder.

Here, the computation means may be configured to calculate, based on the distance information, the first distance change information, and the on-image movement amount information, movement distance information and movement speed information about the movement of the object within the predetermined time interval, and to judge based on this movement distance information and movement speed information whether or not the object is an intruder.

Also, the computation means may include a conversion portion for converting the on-image movement amount information based on the distance information into second distance change information and outputting this second distance change information; a first calculation portion for calculating, based on the first distance change information and the second distance change information, movement distance information of the object and outputting this movement distance information; a second calculation portion for calculating, based on the movement distance information, movement speed information of the object and outputting this movement speed information; and a judgment portion for judging, based on at least the movement distance information and the movement speed information, whether or not the object is an intruder.

In accordance with such a composite intrusion detection sensor, by using a microwave sensor and an image sensor together, their respective weaknesses are compensated, and regardless of the direction of movement of the object suspected to be an intruder, the accurate movement direction and movement speed can always be detected. Thus, for example, occurrences of false alarms due to sunlight, rapid movement of car headlights and the like, and of missed alarms depending upon the direction of movement and the like are avoided as much as possible, improving the reliability of operation.

Also, the composite intrusion detection sensor of the present invention may be configured such that the computation means judges whether or not the object is an intruder by further considering continuity of movement of the object together with the calculated movement distance information and movement speed information.

In accordance with a composite intrusion detection sensor of this kind, together with being able to more accurately detect varied behavior of an illegal intruder, it becomes possible to further decrease false alarms and missed alarms. This further improves the reliability of operation.

### BRIEF DESCRIPTION OF THE DRAWINGS

FIG. 1 is a block diagram showing the overall configuration of a composite intrusion detection sensor according to one embodiment of the present invention.

FIG. 2 is a diagram of the principle by which the composite intrusion detection sensor according to the embodiment detects the actual presence of target, such as an intruder.

FIG. 3 is a diagram of the target displacement ΔW in image data (whose total width is W) from an image sensor comprised by the composite intrusion detection sensor according to the embodiment.

FIG. 4 is a diagram of a relationship between image data and an actual distance.

### DESCRIPTION OF THE PREFERRED EMBODIMENTS

Hereinafter, embodiments of the present invention will be described with reference to the accompanying drawings.

<Composition of Composite Intrusion Detection Sensor 1>

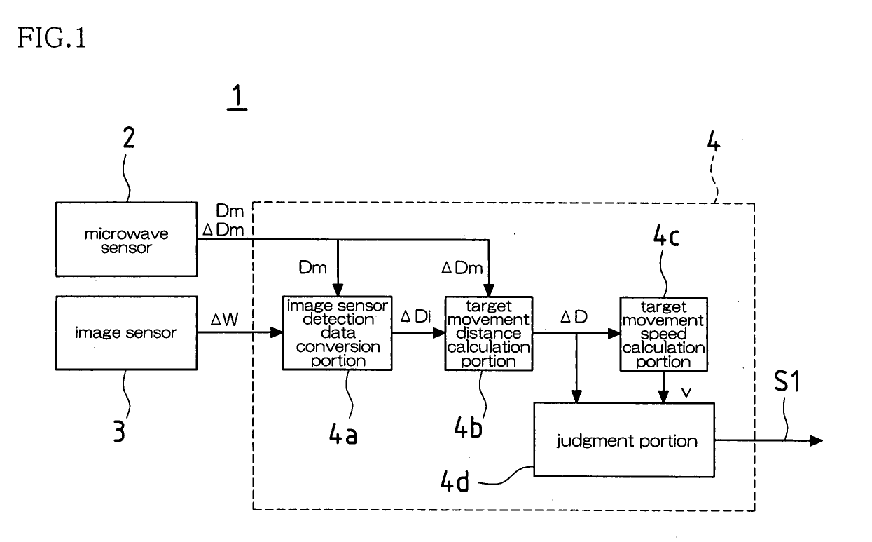

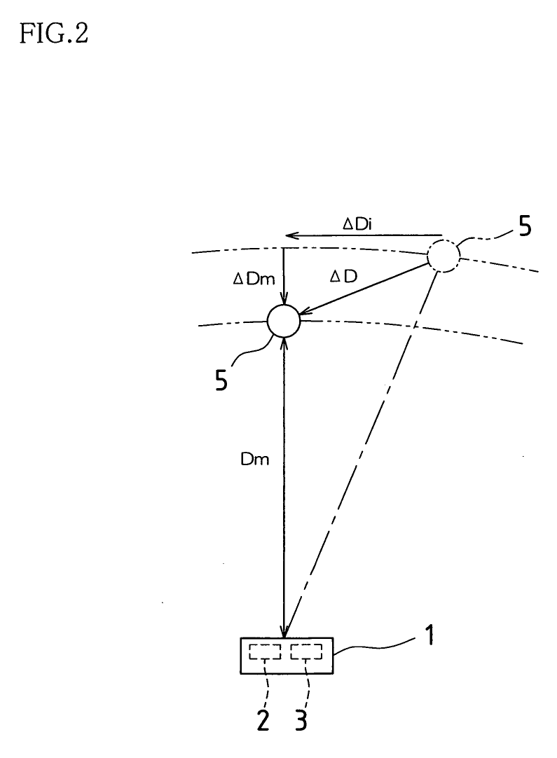

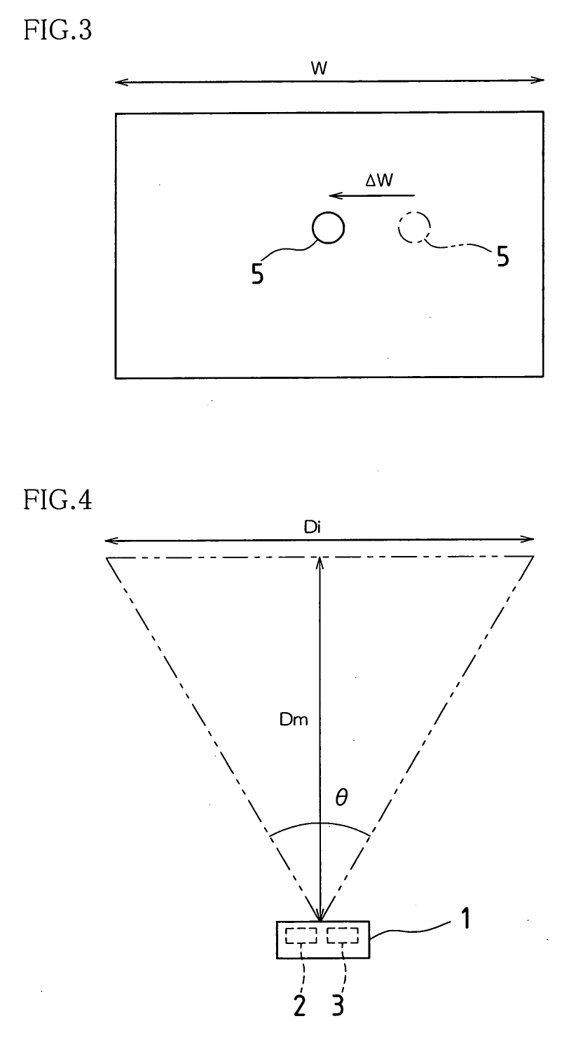

FIG. 1 is a block diagram showing the overall configuration of a composite intrusion detection sensor 1 according to one embodiment of the present invention. FIG. 2 is a diagram of the principle by which this composite intrusion detection sensor 1 detects the actual presence of a target 5, such as an intruder. FIG. 3 is a diagram of the displacement ΔW of the target 5 in image data (whose total width is W) from an image sensor 3 included in this composite intrusion detection sensor 1. FIG. 4 is a diagram of a relationship between the image data and an actual distance.

This composite intrusion detection sensor 1, as shown in FIG. 1, comprises a microwave sensor 2, an image sensor 3 and a computation unit 4. The microwave sensor 2, which detects by microwaves a distance Dm to the target 5, determines an amount of change ΔDm of the distance to the target 5 within a predetermined time interval, and outputs the distance Dm and the amount of distance change ΔDm. The image sensor 3 can detect the target 5 by extracting a motion component from the difference between image frames captured in a time series, and can output a displacement ΔW of the target 5 in the image data within the predetermined time interval. The computation unit 4 judges, based on the output of the microwave sensor 2 and the image sensor 3, whether the target 5 is present or not.

This computation unit 4 includes an image sensor detection data conversion portion 4a, a target movement distance calculation portion 4b, a target movement speed calculation portion 4c, and a judgment portion 4d. Based on the distance Dm output by the microwave sensor 2, the image sensor detection data conversion portion 4a converts the displacement ΔW in the image data output by the image sensor 3 into an amount of change ΔDi of actual distance and outputs this change amount ΔDi. Based on the amount of distance change ΔDi output by this image sensor detection data conversion portion 4a and the amount of distance change ΔDm output by the microwave sensor 2, the target movement distance calculation portion 4b calculates the hactual movement distance ΔD of the target 5 and outputs this actual movement distance ΔD. The target movement speed calculation portion 4c calculates, from the movement distance ΔD output by this target movement distance calculation portion 4b, a movement speed v of the target 5 within the predetermined time interval and outputs this movement speed v. Based on the movement distance ΔD output by the target movement distance calculation portion 4b and the movement speed v output by the target movement speed calculation portion 4c, the judgment portion 4d judges whether or not the target 5 is an actual intruder, and outputs an alarm signal S1 when judging that target 5 is an intruder.

The distance Dm to the target 5 that can be detected by the microwave sensor 2 is the component of the distance in radial direction with respect to the microwave sensor 2, and detection with the microwave sensor 2 is difficult when the target 5 moves in a direction perpendicular to this radial direction. Therefore, also the amount of distance change that the microwave sensor 2 can detect when the target 5 moves is given by the component of the distance in radial direction toward the microwave sensor 2.

As shown in FIG. 2 for example, if the target 5 moves within the predetermined time interval from the upper-right position indicated by the phantom line in lower-left direction (toward the front-left side) to the position indicated by the solid line, the amount of distance change ΔDm that can be detected by the microwave sensor 2 is the component of the actual movement distance ΔD in the above-mentioned radial direction.

On the other hand, within its capturing range, the image sensor 3 can detect the position of the target 5 in the image data, but is unable to directly detect the distance to the target 5. When the target 5 moves, as shown in FIG. 3, the change of the position of the target 5 can be detected as a displacement ΔW in the image data, but if the target 5 decreases or increases its distance while retaining its position in the image data, its movement cannot be detected.

Thus, although, when the target 5 moves, the distance component of the movement distance ΔD in the above-mentioned radial direction cannot be detected by the image sensor 3, it can be directly detected as the amount of distance change ΔDm by the microwave sensor 2. And although the distance component of the movement distance ΔD in the perpendicular direction cannot be detected by the microwave sensor 2, it can be detected by the image sensor 3 as the displacement ΔW in the image data. Therefore, if the displacement ΔW in the image data can be converted to the amount of distance change ΔDi in the perpendicular direction, it can be combined with the amount of distance change ΔDm to determine the actual movement distance ΔD of the target 5.

Furthermore, as shown in FIG. 4, when θ is the image angle of the imaging lens of the image sensor 3, then the actual distance Di corresponding to the entire width W of the image data at the distance Dm from the composite intrusion detection sensor 1 including the image sensor 3 is given by the following formula:
Di=2×Dm×tan(θ/2)
For example, if the distance Dm is Dm=10 [m] and the image angle θ of the imaging lens is θ=90 [deg], it follows that Di=20 [m].

<Computational Processing in Computation Unit 4 of Composite Intrusion detection Sensor 1>

Based on the displacement ΔW in the image data, the amount of distance change ΔDm, the distance Dm to the target 5 and the like, the computation unit 4 calculates the actual movement distance ΔD and the movement speed v of target 5 as follows.

First, the image sensor detection data conversion portion 4a converts the displacement ΔW in the image data according to the following formula:
ΔDi=(ΔW/W)×Di
into the amount of distance change ΔDi.

Then, from the amount of distance change ΔDm and the amount of distance change ΔDi, the target movement distance calculation portion 4b calculates the actual movement distance ΔD of the target 5 according to the following formula:
ΔD=√(ΔDm²+ΔDi²)

Then, the target movement speed calculation portion 4c calculates the movement speed v of the target 5 from the movement distance ΔD according to the following formula:
v=ΔD/ΔT
Here, ΔT is the time needed for the movement of the target 5.

Finally, by comprehensively considering the movement distance ΔD and the movement speed v of the target 5, and furthermore the continuity of the movement of target 5 and the like, the judgment portion 4d judges whether or not the target 5 is an actual intruder. For example, a judgment that there is an actual intruder can be made if the movement distance ΔD of the target 5 is 3 m or more, and the movement speed v is within a range of 0.3˜3.0 m/s.

In accordance with the configuration of the embodiment described above, by using the microwave sensor 2 and the image sensor 3 together, while compensating their respective weaknesses, the movement distance and movement speed of the target 5 can always be accurately calculated. Furthermore, by performing a comprehensive judgment that also includes the continuity of movement of the target 5, it is precisely judged whether or not the target 5 is an actual intruder. From this, for example, occurrences of false alarms due to sunlight, rapid movement of car headlights and the like, and of missed alarms depending on the direction of movement of the target 5 and the like are avoided as much as possible.

The present invention can be embodied and practiced in other different forms without departing from the idea and essential characteristics thereof. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced therein.

1. A composite intrusion detection sensor, comprising:
a microwave sensor that transmits microwaves toward a detection area and based on reflected waves of the microwaves from an object present in the detection area detects and outputs distance information about a distance to the object and first distance change information about a distance change within a predetermined time interval,
an image sensor that captures images within the detection area, and based on changes between images captured in a time series, detects and outputs on-image movement amount information, which represents the amount of movement of the detected object in the images within the predetermined time interval, and
a computation means for judging, based on the distance information, the first distance change information, and the on-image movement amount information whether or not the object is an intruder.

2. The composite intrusion detection sensor according to claim 1,
wherein the computation means, based on the distance information, the first distance change information, and the on-image movement amount information, calculates movement distance information and movement speed information about the movement of the object within the predetermined time interval, and judges based on this movement distance information and movement speed information whether or not the object is an intruder.

3. The composite intrusion detection sensor according to claim 2,
wherein the computation means judges whether or not the object is an intruder by further considering continuity of movement of the object together with the calculated movement distance information and the movement speed information.

4. The composite intrusion detection sensor according to claim 1,
wherein the computation means comprises:
a conversion portion for converting the on-image movement amount information based on the distance information into second distance change information and outputting this second distance change information,
a first calculation portion for calculating, based on the first distance change information and the second distance change information, movement distance information of the object and outputting this movement distance information,
a second calculation portion for calculating, based on the movement distance information, movement speed information of the object and outputting this movement speed information, and
a judgment portion for judging, based on at least the movement distance information and the movement speed information, whether or not the object is an intruder.

5. The composite intrusion detection sensor according to claim 2,
wherein the computation means comprises:
a conversion portion for converting the on-image movement amount information based on the distance information into second distance change information and outputting this second distance change information,
a first calculation portion for calculating, based on the first distance change information and the second distance change information, movement distance information of the object and outputting this movement distance information,
a second calculation portion for calculating, based on the movement distance information, movement speed information of the object and outputting this movement speed information, and
a judgment portion for judging, based on at least the movement distance information and the movement speed information, whether or not the object is an intruder.

6. The composite intrusion detection sensor according to claim 3,
wherein the computation means comprises:
a conversion portion for converting the on-image movement amount information based on the distance information into second distance change information and outputting this second distance change information,
a first calculation portion for calculating, based on the first distance change information and the second distance change information, movement distance information of the object and outputting this movement distance information,
a second calculation portion for calculating, based on the movement distance information, movement speed information of the object and outputting this movement speed information, and
a judgment portion for judging, based on at least the movement distance information and the movement speed information, whether or not the object is an intruder.
